(19) United States
(12) Patent Application Publication
(10) Pub. No.: US 2008/0063967 A1
(43) Pub. Date: Mar. 13, 2008

(54) Method of preparing toner, toner prepared using the method, and method and device for forming image using the toner

(75) Inventors: Yo-da Shin, Jung-gn (KR); Chang-kook Hong, Suwon-si (KR); Min-young Cheong, Seoul (KR); Kyung-yol Yon, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/605,342

(22) Filed: Nov. 29, 2006

(30) Foreign Application Priority Data
Aug. 11, 2006 (KR) 10-2006-0076367

(51) Int. Cl. G03G 9/00

(52) U.S. Cl. 430/109.3

(57) ABSTRACT

A method of preparing toner, which comprises polymerizing a toner composition containing a macromonomer having a hydrophilic group, a hydrophobic group and at least one reactive functional group, one or more polymerizable monomers, a polymerization initiator and a chain transfer agent, to form a polymer latex; mixing the polymer latex with a colorant dispersion of a colorant dispersed in an anionic reactive emulsifier and a nonionic reactive emulsifier, and adding an aggregating agent to aggregate the resulting toner; and separating and drying the aggregated toner. A toner prepared by the method, a method of forming an image using the toner, and an image forming device employing the toner, are also provided. According to the method, a colorant dispersion of a colorant dispersed in a plurality of reactive emulsifiers is used to easily control the particle size and shape of the toner particles, obtain a high resolution image having excellent offset resistance, and provide frictional charging properties and storage stability. A toner exhibiting excellent properties in a high humidity environment can be prepared.

### CROSS-REFERENCE TO RELATED PATENT APPLICATION

This application claims the benefit under 35 U.S.C. § 119(a) of Korean Patent Application No. 10-2006-0076367, filed on Aug. 11, 2006, in the Korean Intellectual Property Office, the disclosure of which is hereby incorporated by reference in its entirety.

### BACKGROUND OF THE INVENTION

1. Field of the Invention

The present invention relates to a method of preparing toner and a toner prepared using the method. In particular the invention relates to a method of preparing a toner using a colorant dispersion which is prepared with a plurality of reactive emulsifiers and to a toner prepared using the method. The invention is further directed to a method of forming an image using the toner, and to an image forming device employing the toner.

2. Description of the Related Art

In an electrophotographic method or an electrostatographic recording method, developers for visualizing electrostatic charge images or electrostatic latent images can be classified into two-component developers, which consist of toner and carrier particles, and one-component developers, which substantially consist of toner only and do not use carrier particles. The one-component developers in turn can be divided into magnetic one-component developers containing a magnetic component, and non-magnetic one-component developers containing no magnetic component. For the non-magnetic one-component developers, fluidizing agents such as colloidal silica and like are often added to the developer in order to enhance the fluidity of the toner. Toner generally comprises colored particles that are prepared by dispersing a colorant such as carbon black, and optionally other additives, in a binding resin, and producing particles therefrom.

Toner can be prepared by pulverization or polymerization methods. The pulverization method comprises melt blending a synthetic resin and a colorant, and optionally other additives, pulverizing the resultant mixture, and then classifying the pulverized particles to obtain a toner comprising particles with a desired particle size. The polymerization method comprises preparing a polymerizable monomer composition in which a colorant, a polymerization initiator, and optionally various additives such as a crosslinking agent, an antistatic agent and the like, are uniformly dissolved or dispersed in a polymerizable monomer; dispersing the polymerizable monomer composition in an aqueous dispersion medium containing a dispersion stabilizer, using a stirrer to form very fine liquid droplets of the polymerizable monomer composition; and then suspension polymerizing the polymerizable monomer composition at an elevated temperature to obtain a polymerized toner comprising colored polymer particles with a desired particle size.

In an image forming device such as an electrophotographic device or an electrostatographic recording device, an image is formed by exposing an image on a uniformly charged photoreceptor to form an electrostatic latent image, attaching toner to the electrostatic latent image to form a toned image, transferring the toned image onto a transfer member such as transfer paper or the like, and then fixing the unfixed toned image on the transfer member by means of various methods, including heating, pressurizing, solvent steaming and the like. In most of the cases during the fixing process, the transfer member onto which the toned image is transferred is passed between a fixing roll and a pressure roll, thereby heat pressing the toner to fuse the toner onto the transfer member.

There has been a demand for improvements in precision and fineness for images formed by image forming devices such as electrophotographic copy machines and the like. Traditionally, toners obtained by the pulverization method have been predominantly used in image forming devices. Since the pulverization method is likely to form colored particles having a broad particle size distribution, it is necessary to adjust the particle size distribution to be somewhat narrower by classifying the pulverization product to obtain satisfactory developing properties. However, those kneading/pulverizing processes that are conventional in the production of toner particles appropriate for an electrophotographic process or an electrostatographic recording process, are accompanied by difficulties in precise control of the particle size and the particle size distribution, and the classification process during the preparation of fine-sized toner particles causes a decreased yield in the toner production. There is also a problem that modification and/or adjustment of toner design to change the charging properties and fixing properties, is restricted. Thus, polymerized toners have recently received attention, since they have advantages such as easy control of the particle size, and the absence of a need for complicated preparation processes such as classification.

When the polymerization method is used to prepare toner, a toner having a desired particle size and a desired particle size distribution can be obtained without performing pulverization or classification.

U.S. Pat. No. 6,033,822 issued to Hasegawa et al. describes a polymerized toner prepared by suspension polymerization, which comprises particles having a core composed of colored polymer particles, and a shell covering the core. However, it is still difficult to control the form and size of the toner particles using this method, and the resulting particle size distribution was is broad.

U.S. Pat. No. 6,258,911 issued to Michael et al. describes a bifunctional polymer having a narrow range of polydispersity, and a method of emulsion-aggregation polymerizing a polymer having covalently bonded free radical groups at both ends of the polymer chain. However, even in this method, surfactants used in the polymerization can result in an adverse effect, and it is still difficult to control the size of the latex particles.

### SUMMARY OF THE INVENTION

In order to address such problems noted above, the present invention provides, a method of preparing toner using a colorant dispersion using a plurality of reactive emulsifiers, which allows easy control of the particle size and particle shape of the toner.

The present invention also provides a toner having excellent properties such as particle size controllability, storability and durability.

The present invention also provides a method of forming an image, which enables low temperature fixing of an image of high resolution, using the toner having excellent particle size controllability, storability and durability.

The present invention also provides an image forming device which allows low temperature fixing of an image of high resolution, where the device employs the toner having excellent particle size controllability, storability and durability.

According to an aspect of the present invention, a method of a preparing toner is provided, where the method comprises polymerizing a toner composition containing a macromonomer having a hydrophilic group, a hydrophobic group and at least one reactive functional group, one or more polymerizable monomers, a polymerization initiator, and a chain transfer agent, to form a polymer latex; mixing the polymer latex with a colorant dispersion containing a colorant dispersed in an anionic reactive emulsifier and a nonionic reactive emulsifier, and adding an aggregating agent to aggregate the resulting toner; and separating and drying the aggregated toner.

According to another aspect of the present invention, a toner is prepared by polymerizing a toner composition containing a macromolecule having a hydrophilic group, a hydrophobic group and at least one reactive functional group, one or more polymerizable monomers, a polymerization initiator, and a chain transfer agent, to form a polymer latex; mixing the polymer latex with a colorant dispersion containing a colorant dispersed in an anionic reactive emulsifier and a nonionic reactive emulsifier, and adding an aggregating agent to aggregate the resulting toner; and separating and drying the aggregated toner.

According to another aspect of the present invention, a method of forming an image using the toner, comprises attaching the toner to the surface of a photoreceptor having an electrostatic latent image formed thereon to form a visible image; and transferring the visible image onto a transfer member.

According to another aspect of the present invention, an image forming device is provided employing the toner, where the device comprises an organic photoreceptor; an image forming unit for forming an electrostatic latent image on the surface of the organic photoreceptor; a receptacle for holding the toner; a toner supplier for supplying the toner onto the surface of the organic photoreceptor to develop the electrostatic latent image into a toned image on the surface of the organic photoreceptor; and a toner transfer unit for transferring the toned image on the surface of the organic photoreceptor onto a transfer member.

According to an embodiment of the present invention, polymers are formed in the presence of a colorant and wax dispersed in the system in a single process, thereby improving the dispersibility of the colorant and the wax. The simplified preparation process allows the production costs to be reduced.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating an image forming device employing a toner prepared according to an embodiment of the present invention;

FIG. 2 is a histogram showing the particle size distribution of the toner prepared according to Example 1 of the present invention;

FIG. 3 is a histogram showing the particle size distribution of the toner prepared according to Example 2 of the present invention;

FIG. 4 is a histogram showing the particle size distribution of the toner prepared according to Example 3 of the present invention;

FIG. 5 is a histogram showing the particle size distribution of the toner prepared according to Example 4 of the present invention;

FIG. 6 is a histogram showing the particle size distribution of the toner prepared according to Example 5 of the present invention;

FIG. 7 is a histogram showing the particle size distribution of the toner prepared according to Example 6 of the present invention;

FIG. 8 is a histogram showing the particle size distribution of the toner prepared according to Comparative Example 1 of the present invention; and

FIG. 9 is a histogram showing the particle size distribution of the toner prepared according to Comparative Example 2 of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein. Rather, these embodiments are provided so that this disclosure will be thorough and complete, and will fully convey the concept of the invention to those skilled in the art.

An embodiment of the present invention provides a method of preparing toner, the method comprising polymerizing a toner composition containing a macromonomer having a hydrophilic group, a hydrophobic group and at least one reactive functional group, one or more polymerizable monomers, a polymerization initiator, and a chain transfer agent, to form a polymer latex; mixing the polymer latex with a colorant dispersion containing a colorant dispersed in an anionic reactive emulsifier and a nonionic reactive emulsifier, and adding an aggregating agent to aggregate the resulting toner; and separating and drying the aggregated toner.

According to the current embodiment of the present invention, the particle size of the resulting toner can be controlled by adjusting the ratio of the amount of the anionic reactive emulsifier with respect to the amount of the nonionic reactive emulsifier contained in the colorant dispersion. The ratio of the amount of the anionic reactive emulsifier with respect to the amount of the nonionic reactive emulsifier may be from about 1:99 to 99:1, for example, from about 1:99 to 80:20. The method according to the current embodiment of the present invention is suitable for use in a process for preparing a toner for high-resolution, low temperature-fixing, high-speed printers. This toner is characterized by easy control of toner image formation, and improved storability and fixability.

When the amount of the anionic reactive emulsifier used is increased, the fraction of fine particles is increased. The use of the anionic emulsifier is advantageous for preparing toner with smaller particle sizes. On the other hand, when the amount of the nonionic reactive emulsifier used is increased, or when the amount of the nonionic reactive emulsifier contained in the colorant dispersion is 20% by weight or more, more spherically shaped toner particles are obtained. Furthermore, when the amount of the nonionic reactive emulsifier contained in the colorant dispersion is 20% by weight or more, the toner can be heated to a temperature of about 85 to 90° C., which is lower than the typical aggregation temperature, and the amount of the aggregating agent to be introduced can be reduced.

The anionic reactive emulsifier and the nonionic reactive emulsifier can be used to control the degree of aggregation, by adjusting the ratio of the amount of the anionic reactive emulsifier relative to the amount of the nonionic reactive emulsifier contained in the colorant dispersion, in accordance with the type of the colorant. For example, black and cyan colorants tend to be readily aggregated, while magenta and yellow colorants are comparatively not readily aggregated. Thus, when using the magenta and yellow colorants, if the amount of the nonionic reactive emulsifier is increased compared to the amount of the nonionic reactive emulsifier used for black and cyan colorants, aggregation may occur more easily.

The colorant dispersion can be prepared by various methods. For example, the colorant dispersion can be prepared by dispersing a colorant separately in an anionic reactive emulsifier and in a nonionic reactive emulsifier, and then mixing the dispersion of colorant in the anionic reactive emulsifier and the dispersion of colorant in the nonionic reactive emulsifier at a predetermined ratio. On the other hand, the colorant dispersion can also be prepared by mixing an anionic reactive emulsifier and a nonionic reactive emulsifier, and dispersing a colorant in the mixed reactive emulsifiers.

According to an embodiment of the present invention, a toner composition containing a macromonomer having a hydrophilic group, a hydrophobic group and at least one reactive functional group, one or more polymerizable monomers, a polymerization initiator, and a chain transfer agent, is polymerized to form a polymer latex. In the meantime, a colorant dispersion is prepared by mixing a colorant with deionized water, an anionic reactive emulsifier and a nonionic reactive emulsifier, and dispersing the resulting mixture using a disperser. The polymer latex is mixed with the colorant dispersion, and an aggregating agent is added to the mixture. The added aggregating agent induces an aggregation reaction, and thus the size and shape of the particles can be controlled. When a desired size and shape are attained, the toner particles thus formed are separated by filtration, and dried. The dried toner particles are then subjected to a surface treatment using silica or the like, and to an adjustment of the amount of electric charge, thereby the final toner product is prepared.

The anionic reactive emulsifier that can be used for the colorant dispersion may be exemplified by, but is not limited to, rosin acid soap, sodium dodecyl sulfate, sodium lauryl sulfate, sodium oleate, potassium oleate, sodium dodecyl benzenesulfonate, sodium dodecyl allyl sulfosuccinate, disodium ethoxylated alcohol half ester of sulfosuccinic acid, sodium dioctyl sulfosuccinate, a proprietary sulfosuccinate blend, or the like.

The nonionic reactive emulsifier that can be used for the colorant dispersion may be exemplified by, but is not limited to, alkyl polyethoxy acrylate, alkyl polyethoxy methacrylate, aryl polyethoxy acrylate, aryl polyethoxy methacrylate, or the like.

The macromonomer according to embodiments of the present invention is an amphiphilic material having both a hydrophilic group and a hydrophobic group, and is a polymer or an oligomer having at least one reactive functional group at the terminal end of the polymer or oligomer chain. The hydrophilic group of the macromonomer, which is chemically bound to the toner particle surface, serves to increase the long term stability of the toner particle by steric stabilization, and helps in controlling the toner particle size according to the amount or molecular weight of the macromonomer introduced. On the other hand, the hydrophobic group of the macromonomer, which is also present on the surface of the toner particle, can promote an emulsion polymerization reaction. According to an embodiment of the present invention, the macromonomer may be copolymerized with the polymerizable monomer(s) contained in the toner composition, to form a copolymer in various forms such as graft copolymer, branched copolymer or crosslinked copolymer.

The polymer latex according to the embodiments of the present invention allows the preparation process to be simplified and the production costs for the polymerized toner to be reduced.

The weight average molecular weight of the macromonomer may be from about 100 to 100,000, for example, from about 1,000 to 10,000. If the weight average molecular weight of the macromonomer is less than 100, the finally obtained toner may not have improved properties, or may not be sufficiently stabilized. If the weight average molecular weight of the macromonomer is greater than 100,000, the conversion rate of the polymerization reaction may be unfavorably lowered.

The macromonomer may be one selected from the group consisting of, for example, polyethylene glycol (PEG)-methacrylate, polyethylene glycol (PEG) ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid-modified epoxy acrylate, and polyester methacrylate, but is not limited thereto.

According to another embodiment of the present invention, the amount of the macromonomer to be used may be from about 1 to 50 parts by weight based on 100 parts by weight of the toner composition. If the amount of the macromonomer is less than 1 part by weight based on 100 parts by weight of the toner composition, the dispersion stability of the particles may be unfavorably decreased. If the amount of the macromonomer exceeds 50 parts by weight, the properties of the toner may be deteriorated.

The polymerizable monomer(s) to be used according to the embodiments of the present invention may be selected from vinyl monomers, polar monomers having a carboxyl group, monomers having an unsaturated polyester group, and monomers having a fatty acid group.

The polymerizable monomer(s) according to an embodiment of the present invention may be at least one selected from the group consisting of styrene monomers such as styrene, vinyltoluene and α-methylstyrene; acrylic acid, methacrylic acid; (meth)acrylic acid derivatives such as methyl acrylate, ethyl acrylate, propyl acrylate, butyl acrylate, 2-ethylhexyl acrylate, dimethylaminoethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitirle, acrylamide and methacrylamide; ethylenically unsaturated monoolefins such as ethylene, propylene and butylenes; vinyl halides such as vinyl chloride, vinylidene chloride and vinyl fluoride; vinyl esters such as vinyl acetate and vinyl propionate; vinyl ethers such as vinyl methyl ether and vinyl ethyl ether; vinyl ketones such as vinyl methyl ketone and methyl isopropenyl ketone; and nitrogen-containing vinyl compounds such as 2-vinylpyridine, 4-vinylpyridine and N-vinylpyrrolidone, but is not limited thereto.

According to another embodiment of the present invention, the amount of the polymerizable monomer(s) to be used may be from about 3 to 50 parts by weight based on 100 parts by weight of the toner composition. If the amount of the polymerizable monomer is less than 3 parts by weight based on 100 parts by weight of the toner composition, the yield may be decreased. If the amount of the polymerizable monomer exceeds 50 parts by weight, the stability may be disadvantageously deteriorated.

The polymerization reaction in the toner composition according to the embodiments of the present invention may occur such that free radicals are generated by the polymerization initiator, and these free radicals react with the polymerizable monomer(s). The free radicals may react with the polymerizable monomer(s) as well as the reactive functional group of the macromonomer to form copolymers.

Examples of the radical polymerization initiator include persulfates such as potassium persulfate, ammonium persulfate, and the like; azo compounds such as 4,4-azobis(4-cyanovalerate), dimethyl-2,2′-azobis(2-methylpropionate), 2,2-azobis(2-amidinopropane) dihydrochloride, 2,2-azobis-2-methyl-N-1,1-bis(hydroxymethyl)-2-hydroxyethylpropionamide, 2,2′-azobis(2,4-dimethylvaleronitrile), 2,2′-azobisisobutyronitrile, 1,1′-azobis(1-cyclohexanecarbonitrile), and the like; peroxides such as methyl ethyl peroxide, di-t-butyl peroxide, acetyl peroxide, dicumyl peroxide, lauroyl peroxide, benzoyl peroxide, t-butylperoxy-2-ethylhexanoate, diisopropylperoxydicarbonate, di-t-butylperoxyisophthalate, and the like, as well other suitable compounds. Oxidation-reduction initiators can also be used, which are combinations of the aforementioned polymerization initiators and reducing agents.

A chain transfer agent is a material which causes an alteration in the species of the chain carrier in a chain reaction, and includes a new chain having markedly reduced activity compared with the previous chains. The chain transfer agent allows the degree of polymerization of a monomer to be decreased and also allows a new chain to be initiated. The chain transfer agent may also be used to control the molecular weight distribution. Examples of the chain transfer agent that can be used include, but are not limited to, sulfur-containing compounds such as dodecanethiol, thioglycolic acid, thioacetic acid and mercaptoethanol; phosphorous acid compounds such as phosphorous acid and sodium phosphite; hypophosphorous acid compounds such as hypophosphorous acid and sodium hypophosphite; and alcohols such as methanol, ethanol, isopropyl alcohol and n-butyl alcohol.

Specific processes for preparing toner according to an embodiment of the present invention are as follows.

A mixture of a medium such as distilled deionized water (or a mixture of water and an organic solvent) and a macromonomer is introduced into a reactor which has been purged with nitrogen gas or the like, and the mixture is heated while stirring. At this time, an electrolyte such as NaCl, or other ionic salt may be added to the mixture in order to control the ionic strength of the reaction medium. When the temperature inside the reactor reaches an appropriate value, a polymerization initiator, for example, a water-soluble free radical initiator, is introduced into the reactor. Subsequently, one or more polymerizable monomers are introduced, preferably together with a chain transfer agent, into the reactor in a semi-continuous manner. Here, feeding of the polymerizable monomer(s) is performed slow enough to create a “starved condition”, so as to control the reaction rate and the degree of dispersion.

The amphiphilic macromonomer can act not only as a co-monomer, but also as a stabilizer. The initial reaction between the free radicals and the polymerizable monomer(s) produces oligomer radicals, and exhibits an in situ stabilization effect. A decomposed polymerization initiator molecule produces a free radical, and this radical reacts with a monomer unit in an aqueous solution to form an oligomer radical, which increased the overall hydrophobicity of the system. The hydrophobic characteristic of the oligomer radical accelerates diffusion of the oligomer radicals into the interior of the micelles, and promotes the reaction between the oligomer radicals and the polymerizable monomer units. At the same time, a copolymerization reaction with the macromonomer can be advanced.

The hydrophilic characteristic of the amphiphilic macromonomer can induce the copolymerization reaction to occur more easily in the vicinity of the surface of a toner particle. The hydrophilic moiety of the macromonomer, which is present on the surface of the toner particle, increases the stability of the toner particle by steric stabilization, and helps in controlling the particle size in accordance with the amount or molecular weight of the macromonomer introduced. The functional group which undergoes a reaction on the particle surface can improve the frictional electrical characteristic of the toner.

The toner according to an embodiment of the present invention contains a colorant and/or a wax. In the case of black toner the colorant may be carbon black or aniline black. A non-magnetic toner is useful for preparing color toner. In the case of preparing color toner, carbon black is used for the black-and-white printing, and yellow, magenta and cyan colorants are added for color printing.

For the yellow colorant, condensed nitrogen compounds, isoindolinone compounds, anthraquinone compounds, azo metal complexes or allylimide compounds may be used. In particular, C.I. Pigments Yellow 12, 13, 14, 17, 62, 74, 83, 93, 94, 95, 109, 110, 111, 128, 129, 147, 168, 180 and the like may be used.

For the magenta colorant, condensed nitrogen compounds, anthraquinone compounds, quinacridone compounds, basic dye lake compounds, naphthol compounds, benzimidazole compounds, thioindigo compounds or perylene compounds may be used. In particular, C.I. Pigments Red 2, 3, 5, 6, 7, 23, 48:2, 48:3, 48:4, 57:1, 81:1, 122, 144, 146, 166, 169, 177, 184, 185, 202, 206, 220, 221, 254 and the like may be used.

For the cyan colorant, copper phthalocyanine compounds and their derivatives, anthraquinone compounds, or basic dye lake compounds are used. Specifically, C.I. Pigments Blue 1, 7, 15, 15:1, 15:2, 15:3, 15:4, 60, 62, 66 and the like may be used.

These colorants may be used alone or as a mixture of two or more species, and are selected while taking color, chromaticity, brightness, weather resistance, dispersibility in toner and the like into consideration.

According to another embodiment of the present invention, the amount of the colorant to be used may be about 0.1 to 20 parts by weight based on 100 parts by weight of the polymerizable monomer. The colorant is not limited to a particular amount so long as the amount is sufficient for coloration of the toner. If the amount of the colorant is less than 0.1 part by weight based on 100 parts by weight of the polymerizable monomer, the coloring effect may not be sufficient. If the amount of the colorant is more than 20 parts by weight, the manufacturing costs of the toner would be increased, and a sufficient amount of frictional charge may not be obtained.

The wax can be selected from any appropriate waxes to provide the characteristics intended for the final toner composition. Examples of the wax that can be used include, but are not limited to, polyethylene waxes, polypropylene waxes, silicone waxes, paraffin waxes, ester waxes, carnauba waxes and metallocene waxes. The melting point of the wax may be about 50 to about 150° C. The wax component is physically adhered to the toner particles, but is not covalently bonded to the toner particles. The wax is useful in providing a toner which can be fixed on the final image receiver at a low fixing temperature, and has excellent image durability and abrasion resistance.

According to an embodiment of the present invention, the aggregating agent may include at least one compound selected from the group consisting of NaCl, MgCl₂.8H₂O, and [Al₂(OH)ₙCl₆₋ₙ]ₘ.

According to another embodiment of the present invention, the toner composition may further contain at least one selected from a releasing agent and a charge control agent.

The releasing agent can be appropriately used to obtain a high resolution image by protecting the photoreceptor and preventing deterioration of the developing properties. The releasing agent according to an embodiment of the present invention may be a highly pure solid fatty acid ester substance. Specific examples thereof include low molecular weight polyolefins such as low molecular weight polyethylene, low molecular weight polypropylene, low molecular weight polybutylene, and the like; paraffin waxes; polyfunctional ester compounds and the like. The releasing agent that is useful according to the current embodiment of the present invention may be a polyfunctional ester compound formed from an alcohol of tri- or higher valent and a carboxylic acid.

Examples of the polyhydric alcohol of tri- or higher valent include aliphatic alcohols such as glycerin, pentaerythritol, pentaglycerol, and the like; alicyclic alcohols such as phloroglucitol, quercitol, inositol, and the like; aromatic alcohols such as tris(hydroxymethyl)benzene, and the like; sugars such as D-erythrose, L-arabinose, D-mannose, D-galactose, D-fructose, L-ramnose, saccharose, maltose, lactose, etc.; sugar alcohols such as erythritol, D-threitol, L-arabitol, adonitol, xylitol, and the like and other suitable alcohols.

Examples of the carboxylic acid include aliphatic carboxylic acids such as acetic acid, butyric acid, caproic acid, enanthic acid, caprylic acid, pelargonic acid, capric acid, undecanoic acid, lauric acid, myristic acid, stearic acid, margaric acid, arachidic acid, cerotic acid, melissic acid, erucic acid, brassidic acid, sorbic acid, linolic acid, linoleic acid, behenic acid, tetrolic acid, xymenic acid, and the like; alicyclic carboxylic acids such as cyclohexanecarboxylic acid, hexahydroisophthalic acid, hexahydroterephthalic acid, 3,4,5,6-tetrahydrophthalic acid, and the like; aromatic carboxylic acids such as benzoic acid, toluic acid, cumic acid, phthalic acid, isophthalic acid, terephthalic acid, trimesic acid, trimellitic acid, hemimellitic acid and the like and other suitable acids.

The charge control agent may be selected from the group consisting of salicylic acid compounds containing a metal such as zinc or aluminum, boron complexes of bisdiphenyl glycolic acid, and silicates. More particularly, zinc dialkyl salicylate, boro bis(1,1-diphenyl-1-oxo-acetyl potassium salt), and the like may be used.

Another embodiment of the present invention provides a toner prepared by polymerizing a toner composition, which contains a macromonomer having a hydrophilic group, a hydrophobic group and at least one reactive functional group, one or more polymerizable monomers, a polymerization initiator, and a chain transfer agent, to form a polymer latex; mixing the polymer latex with a dispersion of a colorant dispersed in an anionic reactive emulsifier and a nonionic reactive emulsifier; adding an aggregating agent to aggregate the resulting toner; and separating and drying the aggregated toner.

The free radicals generated by the polymerization initiator react with the polymerizable monomer(s), or the free radicals react with the polymerizable monomer(s) and the reactive functional group of the macromonomer to form a copolymer. The copolymer can be obtained by copolymerizing at least one selected from vinyl monomers, polar monomers having a carboxylic acid, monomers having an unsaturated polyester group, and monomers having a fatty acid group. The weight average molecular weight of the copolymer may be from about 2,000 to 200,000.

The weight average molecular weight of the macromonomer may be from about 1000 to 10,000, preferably about 1,000 to 10,000. The macromonomer may be one selected from the group consisting of polyethylene glycol (PEG)-methacrylate, polyethylene glycol (PEG) ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid-modified epoxy acrylate, and polyester methacrylate, but is not limited thereto.

The volume average particle size of the toner particles prepared according to an embodiment of the present invention may be from about 0.5 to 20 μm, preferably, from about 5 to 10 μm.

According to another embodiment of the present invention, a method is provided for forming an image, which comprises attaching toner onto the surface of a photoreceptor having an electrostatic latent image formed thereon, to form a visible image, and transferring the visible image onto a transfer member, wherein the toner is prepared by polymerizing a toner composition, which contains a macromonomer having a hydrophilic group, a hydrophobic group and at least one reactive functional group, one or more polymerizable monomers, a polymerization initiator, and a chain transfer agent, to form a polymer latex; mixing the polymer latex with a dispersion of a colorant dispersed in an anionic reactive emulsifier and a nonionic reactive emulsifier; adding an aggregating agent to aggregate the resulting toner; and separating and drying the aggregated toner.

A representative process for forming an electrophotographic image comprises a series of processes for forming an image on a receiver, including charging, exposing, developing, transferring, fixing, cleaning and discharging.

In the charging process, the photoreceptor is usually covered with a charge of a desired polarity, such as a negative charge or a positive charge, using corona discharge or a charged roller. In the exposing process, the charged surface of the photoreceptor is selectively discharged in an imagewise manner by an optical system, which is typically a laser scanner or a diode array, to form a latent image corresponding to the desired image to be formed on the final image receiver. Examples of electromagnetic radiation that can be described as “light” include infrared radiation, visible ray, and ultraviolet radiation.

In the developing process, toner particles having appropriate polarity are generally contacted with the latent image on the photoreceptor, generally using an electrically biased developer having the same potential polarity as the toner polarity. The toner particles are transferred to the photoreceptor, selectively attached to the latent image by electrostatic force, and form a toned image on the photoreceptor.

In the transferring process, the toned image is transferred from the photoreceptor to a targeted final image receiver. Here, an intermediate transfer element may be used to affect the transfer of the toned image from the photoreceptor to the final image receiver, as well as the subsequent transfer of the toned image.

In the fixing process, the toned image on the final image receiver is heated to soften or melt the toner particles, so that the toned image is fixed onto the final image receiver. Another exemplary method of fixing comprises fixing the toner particles onto the final image receiver under high pressure, with or without heating.

In the cleaning process, any residual toner remaining on the photoreceptor is removed. Finally, in the discharging process, the remains of the latent image are removed when the charge on the photoreceptor is exposed to light of a specific wavelength band so that the charge is reduced to a substantially uniformly low value. The discharged photoreceptor is prepared for another image forming cycle.

According to another embodiment of the present invention, there is provided an image forming device comprising a unit for charging the surface of an organic photoreceptor, a unit for forming an electrostatic latent image on the surface of the organic photoreceptor, a unit for holding toner, a unit for supplying the toner to develop the electrostatic latent image on the surface of the organic photoreceptor into a toned image, and a unit for transferring the toner image from the surface of the photoreceptor onto a transfer member, wherein the toner is prepared by polymerizing a toner composition, which contains a macromonomer having a hydrophilic group, a hydrophobic group and at least one reactive functional group, one or more polymerizable monomers, a polymerization initiator, and a chain transfer agent, to form a polymer latex; mixing the polymer latex with a dispersion of a colorant dispersed in an anionic reactive emulsifier and a nonionic reactive emulsifier; adding an aggregating agent to aggregate the resulting toner; and separating and drying the aggregated toner.

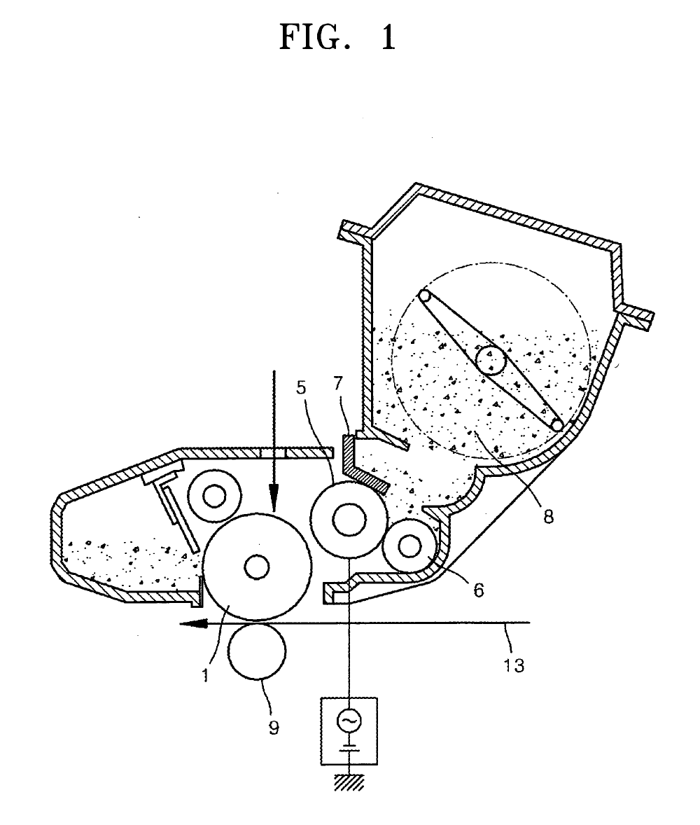

FIG. 1 is a diagram illustrating an image forming device, which employs a toner prepared by the method according to an embodiment of the present invention, and is operated in a non-contact developing mode. The mechanism of operation will be described below.

Referring to FIG. 1, a non-magnetic one-component developer (8), which contains the toner of the present invention, is fed onto a developing roller (5) by a feeding roller (6), which is formed of an elastic material such as polyurethane foam or sponge. The developer (8) fed onto the developing roller (5) is conveyed to the contact portion between a developer regulating blade (7) and the developing roller (5) as the developing roller (5) rotates. The developer regulating blade (7) is formed of an elastic material such as metal or rubber. When the developer (8) passes through the contact portion of the developer regulating blade (7) and the developing roller (5), the layer of the developer (8) is evened into a uniform layer to form a thin layer, and the developer (8) is sufficiently charged. The thin layered developer (8) is transported by the developing roller (5) to a developing region where the developer (8) is used to develop an electrostatic latent image on a photoreceptor (1), which is an electrostatic latent image carrier.

The developing roller (5) is disposed such that the developing roller (5) and the photoreceptor (1) face each other without contacting, that is, with a certain gap between them. The developing roller (5) rotates in an counter-clockwise direction, while the photoreceptor (1) rotates in a clockwise direction. The developer (8) transported to the developing region is used to develop the electrostatic latent image on the photoreceptor (1) by the electromotive force generated by the potential difference between an AC voltage superposed with a DC voltage applied to the developing roller (5), and the potential of the electrostatic latent image on the photoreceptor (1).

The developer (8) attached to the photoreceptor (1) reaches the location of a toner transfer unit (9) along the rotational direction of the photoreceptor (1). The developer (8) attached to the photoreceptor (1) is transferred to a printing paper (13) by corona discharge or by means of a roller, while the printing paper (13) is conveyed by the toner transfer unit (9), where a reverse polarity high voltage is applied to the developer (8), to pass between the photoreceptor (1) and the toner transfer unit (9), and an image is formed on the printing paper (13).

The image transferred onto the printing paper (13) is fixed while the printing paper (13) passes through a high temperature and high pressure fuser (not shown in the figure), whereby the developer is fused to the printing paper (13). Meanwhile, any residual developer remaining unused on the developing roller (5) is recovered by the feeding roller (6) which is in contact with the developing roller (5). The overall process is repeated.

Now the present invention will be described in more detail with reference to the following Examples.

### EXAMPLES

Synthesis of Latex

A mixture of 470 g of distilled deionized water and 5 g of poly(ethylene glycol) ethyl ether methacrylate (PEG-EEM, Sigma-Aldrich Co.) was introduced into a 1-L reactor purged with nitrogen gas, and the mixture was heated while stirring at 250 rpm. When the temperature inside the reactor reached 82° C., a polymerization initiator prepared by dissolving 2.0 g of potassium persulfate (KPS) in 50 g of deionized water, was introduced into the reactor, and then a monomer mixture of styrene, butyl acrylate and methacrylic acid (7:2:1 by weight, 100 g), and 3.5 g of dodecanethiol as a chain transfer agent were added to the reactor in a starved-feeding manner.

In the meantime while the polymerization reaction was continued, 15 g of an ester wax was mixed with a mixture of a monomer mixture of styrene, butyl acrylate and methacrylic acid (ratios of styrene: 80% and methacrylic acid: 2%, fixed; 28.1 g) and 3% by weight of dodecanethiol, while heating the mixture so that it slowly melted. The molten mixture was dispersed in a mixture of 190 g of distilled water and a macromonomer (PEG-EEM or HS-10, Dai-Ichi Kogyo Co., Ltd.) in the same proportion as that for the polymerization reaction, to provide a wax dispersion. The wax dispersion was then introduced into the reactor, and 1 g of KPS dissolved in 40 g of deionized water was also added to the reactor. The reaction time was 4 to 6 hours, and after the reaction was completed, the reaction mixture was naturally cooled while stirring. The particle size of the toner latex particles finally obtained was 400 to 600 nm, and the conversion rate was nearly 100%.

Preparation of Colorant Dispersion

Reactive emulsifiers (HS-10 and RN-10, Dai-Ichi Kogyo Co., Ltd.) and pigments (Black, Cyan, Magenta and Yellow) were respectively dispersed in ultrahigh purity water using a disperser. An ultrasonic disperser and bead milling, or a microfluidizer was used as the disperser.

Two colorant dispersions, A and B, were prepared from the two reactive emulsifiers, respectively, and these colorant dispersions were mixed at predetermined ratios to form different final colorant dispersions. The type of the colorant dispersions and their mixing conditions are presented in Table 1 and Table 2 below.

TABLE 1
Type of colorant dispersions

| | Emulsifier used |
|---|---|
| Colorant dispersion A | HS-10 (Dai-Ichi Kogyo Co., Ltd.) |
| Colorant dispersion B | RN-10 (Dai-Ichi Kogyo Co., Ltd.) |

TABLE 2
Mixing conditions for colorant dispersions

| Mixing condition | Mixing ratio |
|---|---|
| #1 | A:B = 100:0 |
| #2 | A:B = 80:20 |
| #3 | A:B = 70:30 |
| #4 | A:B = 50:50 |
| #5 | A:B = 30:70 |
| #6 | A:B = 20:80 |
| #7 | A:B = 0:100 |

Aggregation and Preparation of Toner

316 g of deionized water and 307 g of a copolymer latex composed of copolymers of styrene, butyl acrylate, methacrylic acid and poly(ethylene glycol) ethyl ether methacrylate with different molecular weights, and containing waxes, which was obtained from the previous polymerization process, were introduced into a 1-L reactor, and the mixture was stirred at 350 rpm. While stirring, 30 g of a pigment mixture dispersed in reactive emulsifiers was introduced into the reactor. After adjusting the pH of the reaction mixture to 11, an aggregating agent MgCl₂.8H₂O was added dropwise to the reactor, and the reaction mixture was heated to 95° C. The reaction mixture was allowed to react at 95° C. for 2 to 4 hours, then NaCl was introduced to the reactor, and the reaction mixture was allowed to react further, until particles of a desired size and shape were obtained. The reaction mixture was cooled to a temperature below the glass transition temperature Tg of the polymer latex, and the formed toner particles were separated by filtration and dried. The dried toner particles were subjected to a surface treatment with silica or the like, and an adjustment of the amount of electric charge. Thus, a final dry toner for laser printers was prepared.

### Example 1

316 g of deionized water and 307 g of the latex synthesized in the latex preparation process as described above [copolymer latex composed of styrene, butyl acrylate, methacrylic acid and poly(ethylene glycol) ethyl ether methacrylate] were introduced into a 1-L reactor, and the reaction mixture was stirred at 350 rpm. While stirring, 30 g of a final colorant dispersion prepared by mixing colorant dispersions of Black pigment dispersed in the respective reactive emulsifiers under the mixing condition #4 (A:B=50:50), was introduced into the reactor. After adjusting the pH of the reaction mixture to 11, 30 g of MgCl₂.8H₂O was added dropwise to the reactor, and the reaction mixture was heated to 95° C. The reaction mixture was allowed to react at 95° C. for 2 hours, then NaCl was added to the reactor, and the reaction mixture was allowed to react further for 4 hours. The reaction mixture was then cooled to a temperature below Tg of the polymer latex, and the formed toner particles were separated by filtration and dried. The synthesized toner had a narrow particle size distribution with a volume average particle size of about 6.63 μm, and very fine particles were not present.

### Example 2

A toner was prepared in the same manner as in Example 1, except that 30 g of a final colorant dispersion prepared by mixing colorant dispersions of Black pigment dispersed in the respective reactive emulsifiers under the mixing condition #6 was used. The synthesized toner had a narrow particle size distribution with a volume average particle size of about 5.315 μm.

### Example 3

A toner was prepared in the same manner as in Example 1, except that 30 g of a final colorant dispersion prepared by mixing colorant dispersions of Black pigment dispersed in the respective reactive emulsifiers under the mixing condition #2 was used. The synthesized toner had a narrow particle size distribution with a volume average particle size of about 5.97 μm.

### Example 4

A toner was prepared in the same manner as in Example 1, except that 35 g of a final colorant dispersion prepared by mixing colorant dispersions of Yellow pigment dispersed in the respective reactive emulsifiers under the mixing condition #6 was used. The synthesized toner had a narrow particle size distribution with a volume average particle size of about 6.28 μm.

### Example 5

A toner was prepared in the same manner as in Example 1, except that 25 g of a final colorant dispersion prepared by mixing colorant dispersions of Cyan pigment dispersed in the respective reactive emulsifiers under the mixing condition #2 was used. The synthesized toner had a narrow particle size distribution with a volume average particle size of about 5.53 μm.

### Example 6

A toner was prepared in the same manner as in Example 1, except that 30 g of a final colorant dispersion prepared by mixing colorant dispersions of Magenta pigment dispersed in the respective reactive emulsifiers under the mixing condition #6 was used. The synthesized toner had a narrow particle size distribution with a volume average particle size of about 7.43 μm.

### Comparative Example 1

346 g of copolymer latex particles prepared by copolymerizing styrene, butyl acrylate and methacrylic acid in the presence of an emulsifier, was added to 307 g of ultrahigh purity water in which 2.0 g of SDS emulsifier was dissolved, and the latex mixture was stirred. Then, 18.2 g of an aqueous dispersion of pigment particles (Cyan 15:3, 40% of solids) dispersed by SDS emulsifier, and a wax dispersion dispersed by SDS emulsifier were added to the latex mixture, and mixed. While stirring at 350 rpm, the pH of the latex-pigment dispersion was adjusted to pH 10 using a 10% NaOH buffer solution. 10 g of MgCl₂.8H₂O as an aggregating agent was dissolved in 30 g of ultrahigh purity water, and then this solution was added dropwise to the latex-pigment dispersion over 10 minutes. Subsequently, the temperature of the resulting reaction mixture was elevated to 95° C., and the reaction mixture was heated at the same temperature for 7 hours. When a desired particle size was attained, the reaction was terminated, and the reaction mixture was naturally cooled. The particles obtained had a volume average particle size of about 10.92 μm.

### Comparative Example 2

A toner was prepared in the same manner as in Example 1, except that 30 g of a final colorant dispersion prepared by mixing colorant dispersions of Black pigment dispersed in the respective reactive emulsifiers under the mixing condition #1 was used. The synthesized toner had a volume average particle size of about 6.26 μm, and a large quantity of very fine particles (latex particles having a particle size of 1 μm or less) was present.

### Comparative Example 3

A toner was prepared in the same manner as in Example 1, except that 30 g of a final colorant dispersion prepared by mixing colorant dispersions of Black pigment dispersed in the respective reactive emulsifiers under the mixing condition #7 was used. The synthesized toner had a volume average particle size of about 7.92 μm. Very fine particles were not found, but the particle size distribution was very broad.

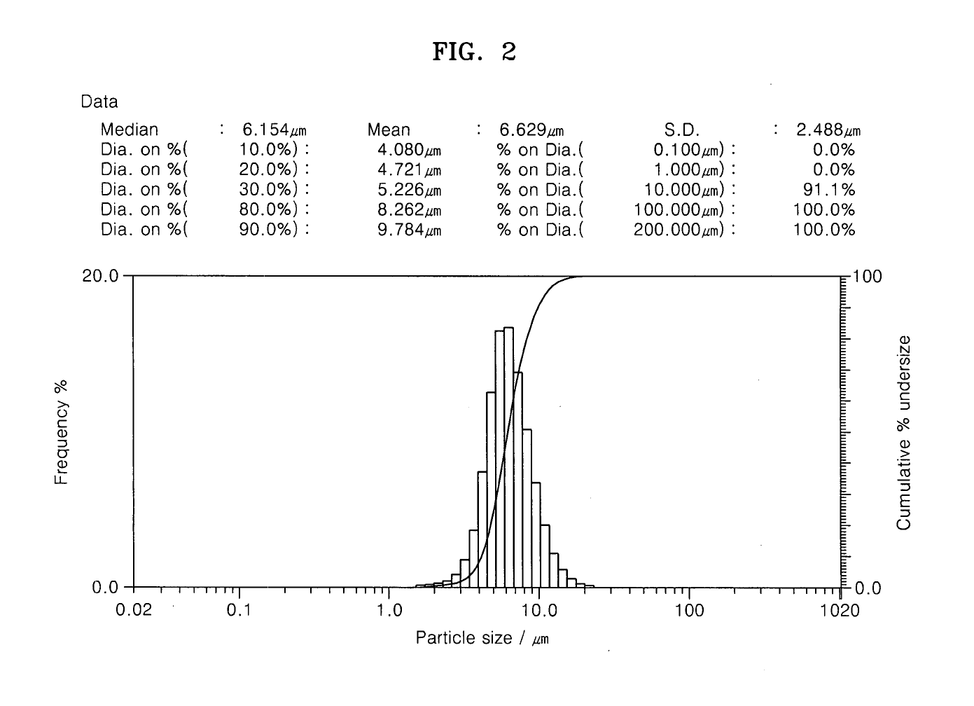

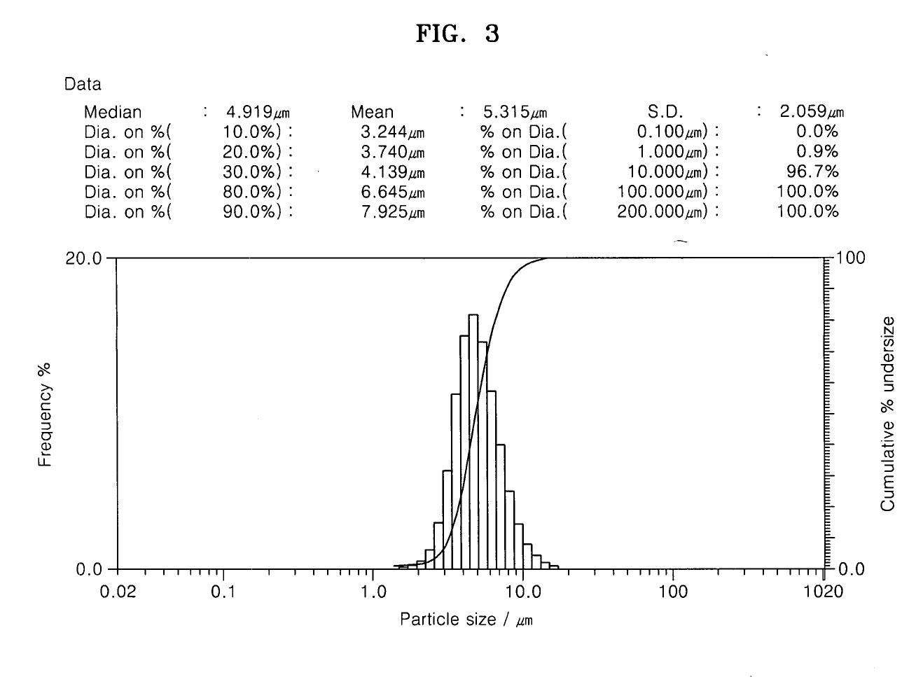

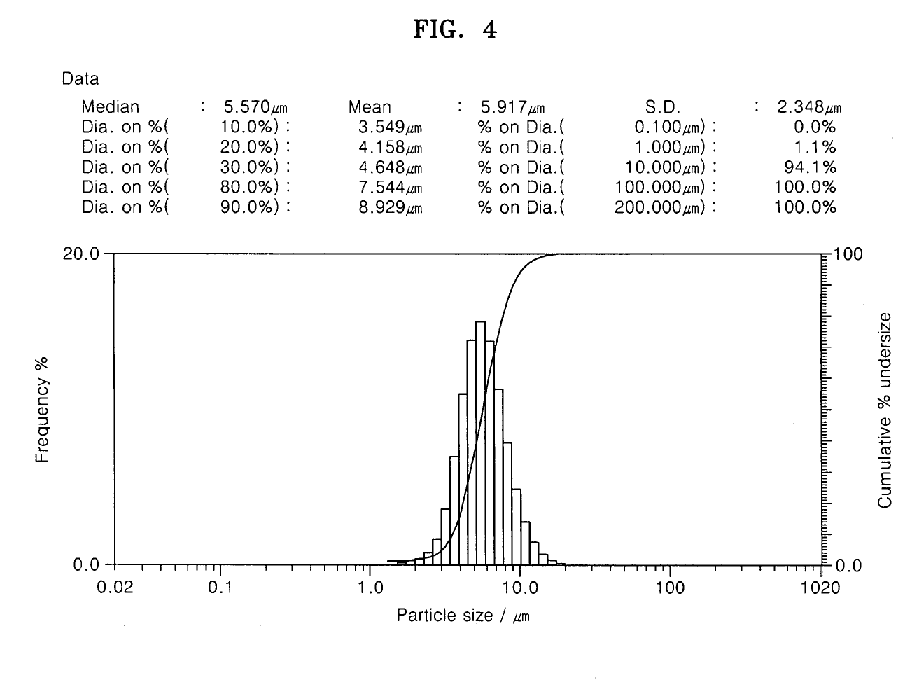

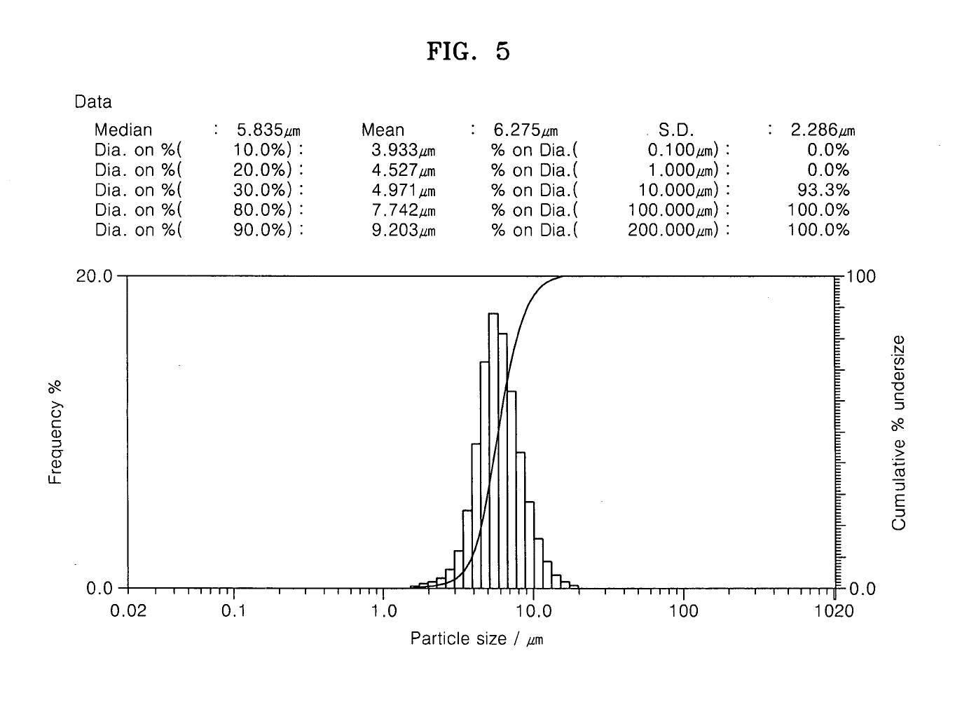

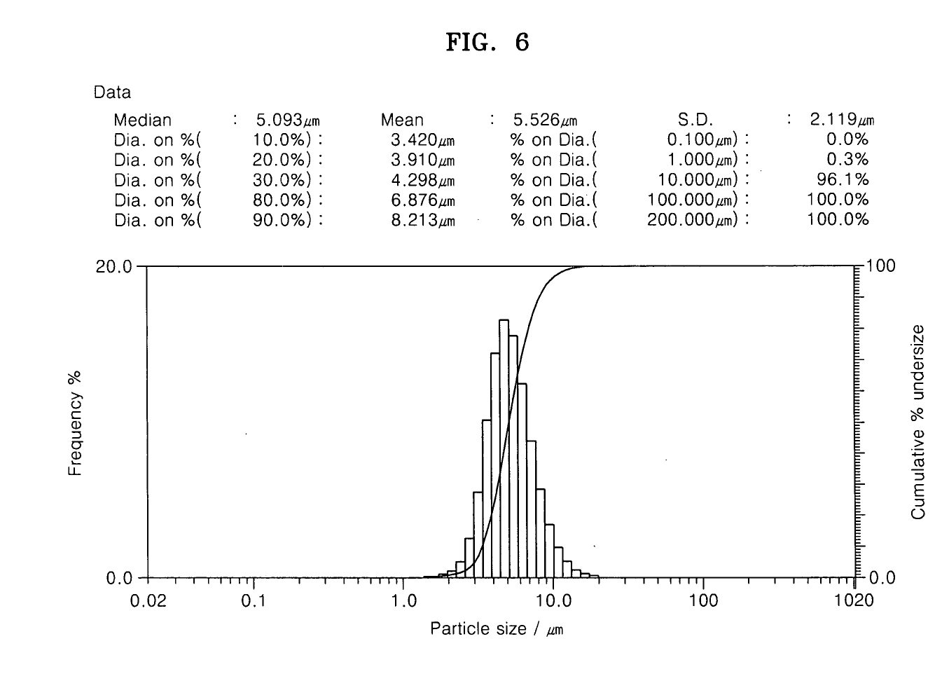

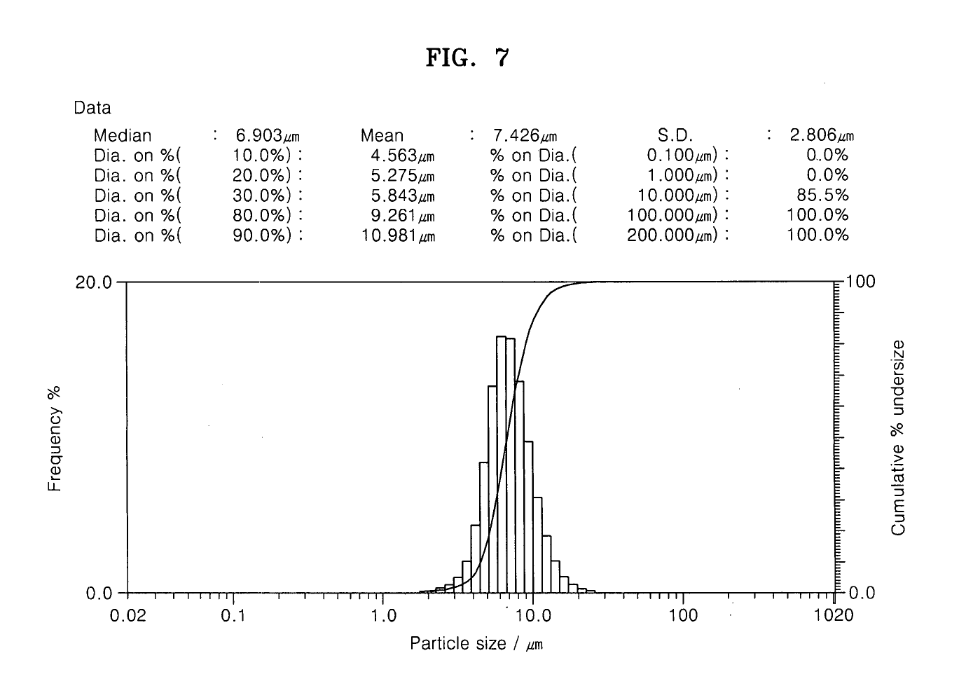

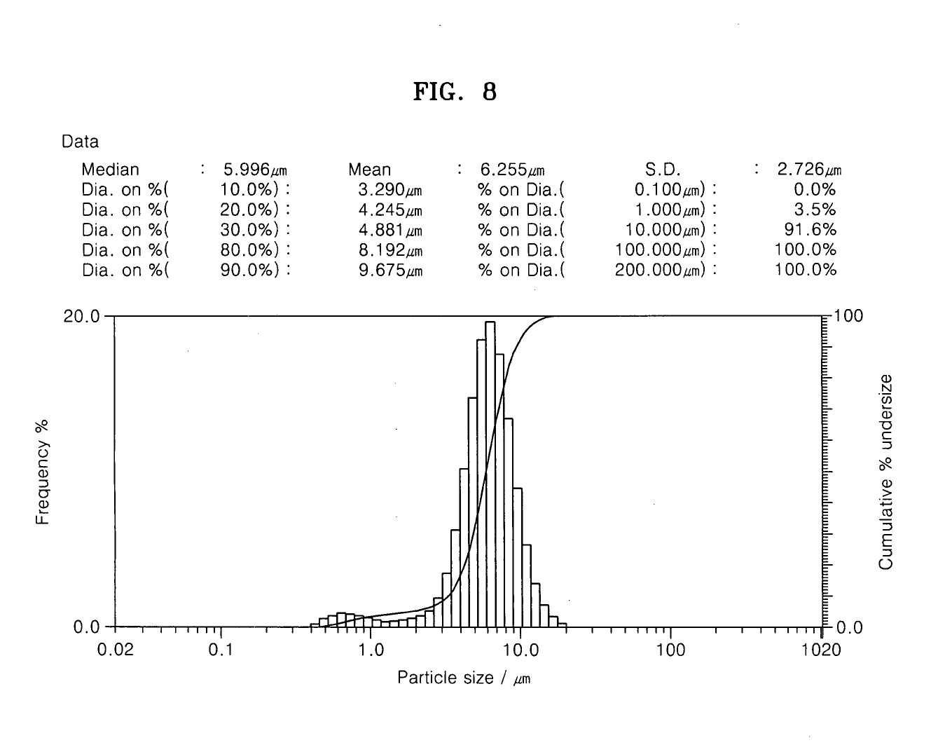

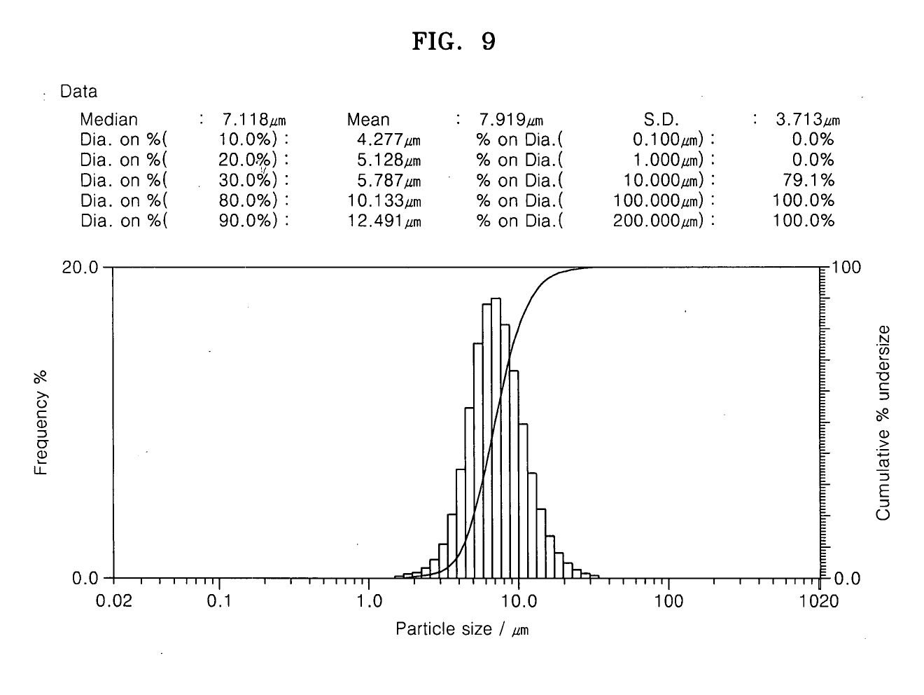

The histograms showing the particle size distributions of the toners prepared in Examples 1 to Example 6, Comparative Example 2 and Comparative Example 3 are presented in FIG. 2 to FIG. 9, respectively.

Referring to the histograms, Example 1 to Example 6 resulted in toner particles of small particle sizes with narrow particle size distributions, having a less amount of very fine particles. On the other hand, the preparation process in Comparative Example 1 was conducted in a conventional manner, and resulted in toner particles of a large particle size. Comparative Example 2 and Comparative Example 3 used colorant dispersions prepared by dispersing the colorant in an anionic reactive emulsifier alone or in a nonionic reactive emulsifier alone. Comparative Example 2 resulted in a large quantity of very fine particles being present in the toner, while Comparative Example 3 resulted in toner particles with a broad particle size distribution, thus necessitating an improvement in the particle size distribution.

According to the present invention, when a colorant is used in the form of a dispersion in an anionic reactive emulsifier and a nonionic reactive emulsifier, the size and shape of the toner particles obtained can be easily controlled, and preparation of a toner having a small particle size can be favorably carried out. High resolution images having excellent offset resistance, frictional charging properties and storage stability can be formed, and a polymerized toner exhibiting excellent properties in a high humidity environment can be prepared.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing toner, the method comprising:
polymerizing a toner composition containing a macromonomer having a hydrophilic group, a hydrophobic group and at least one reactive functional group, one or more polymerizable monomers, a polymerization initiator and a chain transfer agent, and forming a polymer latex;
mixing the polymer latex with a colorant dispersion of a colorant dispersed in an anionic reactive emulsifier and a nonionic reactive emulsifier, and adding an aggregating agent to aggregate the resulting toner; and
separating and drying the aggregated toner.

2. The method of claim 1, wherein the anionic reactive emulsifier includes at least one emulsifier selected from the group consisting of rosin acid soap, sodium dodecyl sulfate, sodium lauryl sulfate, sodium oleate, potassium oleate, sodium dodecyl benzenesulfonate, sodium dodecyl allyl sulfosuccinate, disodium ethoxylated alcohol half ester of sulfosuccinic acid, sodium dioctyl sulfosuccinate, and a proprietary sulfosuccinate blend.

3. The method of claim 1, wherein the nonionic reactive emulsifier includes at least one emulsifier selected from the group consisting of alkyl polyethoxy acrylate, alkyl polyethoxy methacrylate, aryl polyethoxy acrylate, and aryl polyethoxy methacrylate.

4. The method of claim 1, wherein the ratio of the amount of the anionic reactive emulsifier relative to the amount of the nonionic reactive emulsifier contained in the colorant dispersion is from about 1:99 to 99:1.

5. The method of claim 1, wherein the ratio of the amount of the anionic reactive emulsifier relative to the amount of the nonionic reactive emulsifier contained in the colorant dispersion is from about 1:99 to 80:20.

6. The method of claim 5, wherein the aggregating process is performed at an elevated temperature of about 85 to 90° C.

7. The method of claim 1, wherein the colorant dispersion is prepared by dispersing the colorant separately in the anionic reactive emulsifier and the nonionic reactive emulsifier, and mixing the anionic reactive emulsifier with dispersed colorant and the nonionic reactive emulsifier with dispersed colorant.

8. The method of claim 1, wherein the colorant dispersion is prepared by mixing the anionic reactive emulsifier and the nonionic reactive emulsifier, and dispersing the colorant in the mixed reactive emulsifiers.

9. The method of claim 1, wherein the colorant is one selected from the group consisting of Yellow pigments, Magenta pigments, Cyan pigments and Black pigments.

10. The method of claim 1, wherein the macromonomer is selected from the group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxyl polyester acrylate, fatty acid modified epoxy acrylate, and polyester methacrylate.

11. The method of claim 1, wherein the amount of the macromonomer contained in the toner composition is from about 1 to 50 parts by weight based on 100 parts by weight of the toner composition.

12. The method of claim 1, wherein the polymerizable monomers include one or more monomers selected from the group consisting of vinyl monomers, polar monomers having a carboxyl group, monomers having an unsaturated polyester group, and monomers having a fatty acid group.

13. The method of claim 12, wherein the polymerizable monomers are selected from the group consisting of styrene monomers, (meth)acrylic acid derivatives, ethylenically unsaturated monoolefinic monomers, vinyl halides, vinyl ketones, vinyl ethers, and nitrogen containing vinyl compounds.

14. The method of claim 12, wherein the polymerizable monomers include one or more monomers selected from the group consisting of styrene, vinyltoluene, α-methylstyrene,; acrylic acid, methacrylic acid; methyl acrylate, ethyl acrylate, propyl acrylate, butyl acrylate, 2-ethylhexyl acrylate, dimethylaminoethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, methacrylamide, propylene, butylenes, vinyl chloride, vinylidene chloride, vinyl fluoride; vinyl acetate, vinyl propionate, vinyl methyl ether, vinyl ethyl ether, vinyl methyl ketone, methyl isopropenyl ketone, 2-vinylpyridine, 4-vinylpyridine and N-vinylpyrrolidone.

15. The method of claim 1, wherein the amount of the polymerizable monomers contained in the toner composition is from about 3 to 50 parts by weight based on 100 parts by weight of the toner composition.

16. The method of claim 1, wherein the aggregating agent includes at least one compound selected from the group consisting of NaCl, MgCl₂.8H₂O and [Al₂(OH)ₙCl₆₋ₙ]ₘ.

17. The method of claim 1, wherein the toner composition further comprises at least one component selected from a charge control agent and a releasing agent.

18. A toner prepared by polymerizing a toner composition containing a macromonomer having a hydrophilic group, a hydrophobic group and at least one reactive functional group, one or more polymerizable monomers, a polymerization initiator and a chain transfer agent, to form a polymer latex; mixing the polymer latex with a colorant dispersion of a colorant dispersed in an anionic reactive emulsifier and a nonionic reactive emulsifier, and adding an aggregating agent to aggregate the resulting toner; and separating and drying the aggregated toner.

19. The toner of claim 18, wherein the anionic reactive emulsifier includes at least one emulsifier selected from the group consisting of rosin acid soap, sodium dodecyl sulfate, sodium lauryl sulfate, sodium oleate, potassium oleate, sodium dodecyl benzenesulfonate, sodium dodecyl allyl sulfosuccinate, disodium ethoxylated alcohol half ester of sulfosuccinic acid, sodium dioctyl sulfosuccinate, and a sulfosuccinate blend.

20. The toner of claim 18, wherein the nonionic reactive emulsifier includes at least one emulsifier selected from the group consisting of alkyl polyethoxy acrylate, alkyl polyethoxy methacrylate, aryl polyethoxy acrylate, and aryl polyethoxy methacrylate.

21. The toner of claim 18, wherein the volume average particle size of the toner particles is from about 0.5 to 20 μm.

22. The toner of claim 18, wherein the ratio of the amount of the anionic reactive emulsifier relative to the amount of the nonionic reactive emulsifier contained in the colorant dispersion is from about 1:99 to 99:1.

23. The toner of claim 18, wherein the ratio of the amount of the anionic reactive emulsifier to the amount of the nonionic reactive emulsifier contained in the colorant dispersion is from about 1:99 to 80:20.

24. The toner of claim 18, wherein the macromonomer is selected from the group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxyl polyester acrylate, fatty acid modified epoxy acrylate, and polyester methacrylate.

25. A method of forming an image, the method comprising attaching the toner of claim 18 to the surface of a photoreceptor where an electrostatic latent image is formed, to form a visible image; and transferring the visible image onto a transfer member.

26. An image forming device comprising:
an organic;
an image forming unit for forming an electrostatic latent image on the surface of the organic photoreceptor;
a receptacle for holding the toner of claim 18;
a toner supplier for supplying the toned onto the surface of the organic photoreceptor in order to develop the electrostatic latent image on the surface of the organic photoreceptor into a toner image; and
a toner transfer unit for transferring the toned image from the surface of the organic photoreceptor to a transfer member.
